(19) United States
(12) Patent Application Publication
(10) Pub. No.: US 2008/0133151 A1
(43) Pub. Date: Jun. 5, 2008

(54) System and method for determining pipe flow parameters

(76) Inventors: Yung T. Bui, Peoria, IL (US); Neil A. Terry, Edelstein, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/606,177

(22) Filed: Nov. 30, 2006

(51) Int. Cl. G01N 11/00

(52) U.S. Cl. 702/50

(57) ABSTRACT

A method is disclosed for providing one or more fluid parameter values of a piping system. The method includes providing one or more initial fluid parameter values as an initial set of fluid parameter values, providing one or more piping parameter values for a first segment of the piping system as a first set of piping parameter values, and providing one or more piping parameter values for a second segment of the piping system as a second set of piping parameter values. The method also includes automatically determining one or more additional fluid parameter values of the piping system, based at least on the initial set of fluid parameter values, the first set of piping parameter values, and the second set of piping parameter values. The method additionally includes providing the one or more additional fluid parameter values to a computer system.

### TECHNICAL FIELD

The present disclosure relates generally to a pipe flow analysis method and system, and more particularly, to a system and method for determining pipe flow parameters.

### BACKGROUND

Piping systems, such as exhaust systems and water flow systems, are typically designed using computer software tools. These tools may permit a user to select portions of a piping system to include in a design model. The tools may also allow users to evaluate certain aspects of the piping system. For example, based on the dimensions and layout of the piping system design, a computer program may determine certain properties associated with the piping system or a portion of the piping system. Some of these properties include pressure, flow rate, and cost. Although current piping system software tools permit evaluation of certain fluid properties, these tools fail to provide an easy-to-use interface that allows users to enter piping parameter values for individual segments and, based on the parameter values, determine fluid properties associated with the segments and the piping system as a whole.

One piping system design tool is described in U.S. Pat. No. 5,768,149, issued to Umney et al. (“the '149 patent”). The '149 patent describes a user interface for selecting tube segments for a tube system. The interface allows a user to select different types of segments and to select parameters associated with the segments. The parameters are used to determine which tube segments may be connected to other tube segments. Although the system described in the '149 patent allows users to enter certain pipe parameters, it fails to provide an easy-to-use interface that allows users to evaluate and view fluid parameters that are determined based on entered pipe parameters. The system further fails to evaluate fluid parameters associated with individual piping segments or to compare those parameters with similar parameters of the overall piping system.

The disclosed system is directed to overcoming one or more of the problems set forth above.

### SUMMARY OF THE INVENTION

In one embodiment, a method is disclosed for providing one or more fluid parameter values of a piping system. The method includes providing one or more initial fluid parameter values as an initial set of fluid parameter values, providing one or more piping parameter values for a first segment of the piping system as a first set of piping parameter values, and providing one or more piping parameter values for a second segment of the piping system as a second set of piping parameter values. The method also includes automatically determining one or more additional fluid parameter values of the piping system, based at least on the initial set of fluid parameter values, the first set of piping parameter values, and the second set of piping parameter values. The method additionally includes providing the one or more additional fluid parameter values to a computer system.

In another embodiment, a computer program product is disclosed. The computer program product includes a computer readable medium with computer program instructions stored thereon. The computer program instructions cause a computer system to perform certain steps. The steps include storing one or more initial fluid parameter values as an initial set of fluid parameter values, storing one or more piping parameter values for a first segment of the piping system as a first set of piping parameters value, and storing one or more piping parameter values for a second segment of the piping system as a second set of piping parameter values. The steps also include automatically determining the one or more additional fluid parameter values of the piping system, based at least on the initial set of fluid parameter values, the first set of piping parameter values, and the second set of piping parameter values. The steps additionally include storing the one or more additional fluid parameter values.

In another embodiment, a method is disclosed for simultaneously displaying one or more fluid parameter values for a segment of a piping system and one or more fluid parameter values for the overall piping system. The method includes receiving one or more initial fluid parameter values as an initial set of fluid parameter values, receiving one or more piping parameter values for a first piping segment of the piping system as a first set of piping parameter values via a graphical user interface, and receiving one or more piping parameter values for a second piping segment of the piping system as a second set of piping parameter values via a graphical user interface. The method includes automatically determining the one or more fluid parameter values for the overall piping system, based at least on the initial set of fluid parameter values, the first set of piping parameter values, and the second set of piping parameter values. The method additionally includes automatically determining the one or more fluid parameter values for the first segment of the piping system, based at least on the initial set of fluid parameter values and the first set of piping parameter values. The method further includes simultaneously displaying the one or more fluid parameter values for the overall piping system and the one or more fluid parameter values for the first segment of the piping system.

### BRIEF DESCRIPTION OF THE DRAWINGS

FIG. 1 is a diagrammatic illustration of an exemplary analysis system according to certain disclosed embodiments;

FIG. 2 is a diagram of an exemplary piping system consistent with certain disclosed embodiments;

FIG. 3 is an illustration of an exemplary user interface consistent with certain disclosed embodiments;

FIG. 4a is an illustration of another exemplary user interface consistent with certain disclosed embodiments;

FIG. 4b is an example of reference information related to a straight piping segment;

FIG. 4c is an example of reference information related to a conical diffuser piping segment;

FIG. 5 is an illustration of exemplary charts consistent with certain disclosed embodiments;

FIG. 6 is an illustration of another exemplary user interface consistent with certain disclosed embodiments;

FIG. 7 is an illustration of an exemplary graph consistent with certain disclosed embodiments;

FIG. 8a is an illustration of an exemplary web-based user interface consistent with certain disclosed embodiments;

FIG. 8b is an illustration of an exemplary web-based user interface consistent with certain disclosed embodiments;

FIG. 8c is an illustration of another exemplary web-based user interface consistent with certain disclosed embodiments;

FIG. 9 is a block diagram of an exemplary method consistent with certain disclosed embodiments.

### DETAILED DESCRIPTION

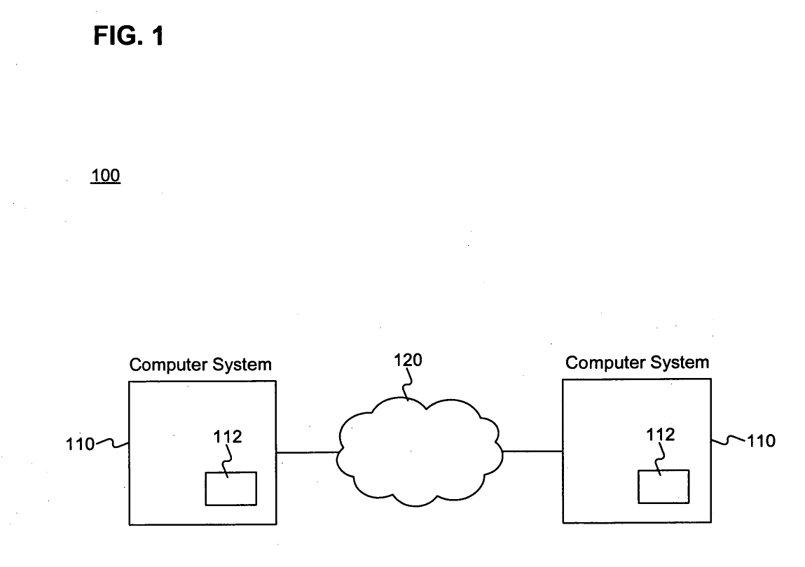

FIG. 1 depicts an exemplary system 100 for implementing one or more disclosed embodiments. The system may include any number of computer systems 110 or other communication systems, and may include one or more networks 120 over which the computer systems may communicate. Computer systems 110 may include one or more computer or data processing devices that have hardware (e.g., processors, storage memory, data buses, network interface, etc.), software (e.g., application programs, operating systems, other executable program code written in any known programming language such as C, C++, Java™, etc.), and/or firmware (e.g., software embedded in a hardware device). One or more hardware, software, and/or firmware modules on one or more computer systems may be used to process data in accordance with the disclosed embodiments. Computer systems 110 may include one or more computer-readable media 112 for storing instructions used to implement one or more of the disclosed embodiments. A computer-readable medium, as referred to herein, may include any type of storage device capable of storing data (e.g., magnetic, optical, or electronic storage media, such as floppy disk, CD, DVD, hard disk, flash memory, DVD, etc.). Data may also be stored in a carrier wave, which may be transmitted between computer systems over a network, such as the Internet.

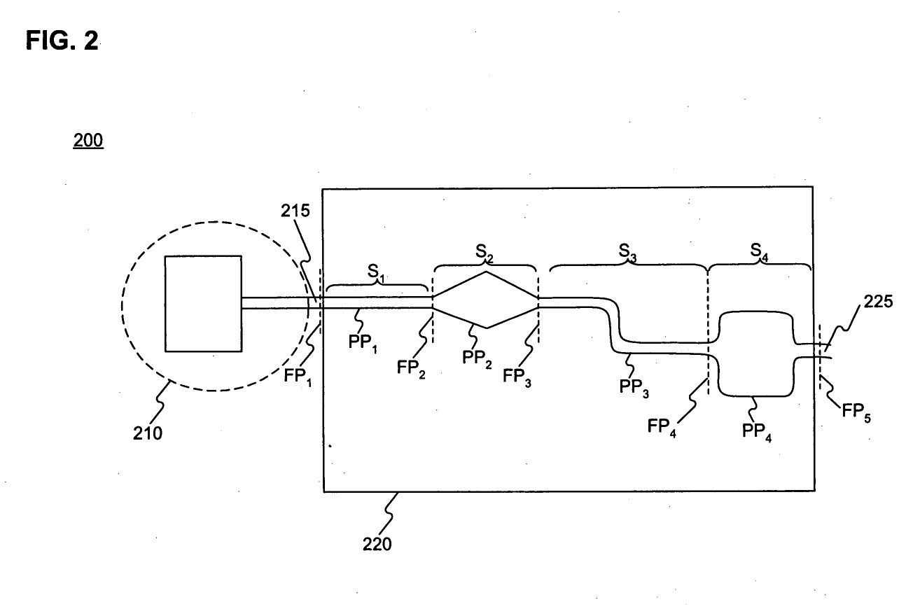

FIG. 2 depicts an exemplary piping system 200 that may be modeled, designed, tested, and/or analyzed according to one of more of the disclosed embodiments. In one embodiment, piping system 200 may include an exhaust system for a vehicle or other machine. However, piping system 200 may include any system that uses pipes or other devices to transfer fluids (e.g., liquid, gas, etc.) input from the system to an output location.

In one embodiment, piping system 200 includes a fluid generation system 210 and a fluid transfer system 220. Fluid generation system 210 may include any system that produces a fluid output that may be input into fluid transfer system 220. For example, in one embodiment, fluid generation system 210 may include an engine system that produces exhaust gases. The exhaust gases then serve as the input to fluid transfer system 220. However, fluid generation system 210 is not limited to an engine. In other embodiments, fluid generation system 210 may include a separate fluid transfer system, similar to that shown as fluid transfer system 220, that inputs one or more fluids into fluid transfer system 220. In other embodiments, fluid generation system 210 may include a water source, or other liquid source, that dispenses liquid into fluid transfer system 220.

In one embodiment, fluid transfer system 220 includes one or more segments, S₁, S₂, S₃, S₄ (referred to as “piping segments”) for transferring fluid from an input node 215 to an output node 225. Although four piping segments are shown, FIG. 2 is exemplary only, and any number of piping segments may be included in fluid transfer system 220. Piping segments of fluid transfer system 220 may include any type of element capable of transporting fluid. For example, a piping segment may include a straight pipe section, bent pipe section, conical shaped nozzle or diffuser, grid, a muffler, or other element used to transport the fluid output from fluid generation system 210.

Each piping segment may be associated with certain piping parameters, PP₁, PP₂, PP₃, PP₄. Although four sets of piping parameters are depicted, FIG. 2 is exemplary only and may include any number of sets of piping parameters associated with respective piping segments. Piping parameters may be categorized by internal piping parameters and external piping parameters. Internal piping parameters refer to parameters associated with the piping segment itself (e.g., size, material, shape, etc.). External piping parameters refer to parameters associated with sources external to the piping segments (e.g., external temperature, wind velocity, etc.). Piping parameters for different piping segments may vary. For example, in one embodiment, piping parameters for a straight pipe section may include length, width (e.g., radius), roughness, pipe thickness, external temperature, external wind velocity, etc. Piping parameters for a bent pipe may additionally include bend angle, bend radius, and similar measurements. Other types of piping segments may include additional parameters. For example, conical segments (e.g., conical nozzles, conical diffusers) may additionally include inlet diameter and outlet diameter, and grid plates may include inlet diameter, hole diameter, and area ratio (e.g., hole-area to overall grid area ratio). Catalyst and filter segments may include parameters such as wall thickness, cell density, effective length, effective diameter, and wall permeability.

Also associated with piping system 200 are a number of fluid parameters, FP₁, FP₂, FP₃, FP₄, FP₅. Although five sets of fluid parameters are depicted, FIG. 2 is exemplary only and may include any number of sets of fluid parameters associated with respective piping segments. Fluid parameters include information reflecting the properties of the fluid passing through a particular point in piping system 200. For example, in one embodiment, fluid parameters include fluid flow rate, temperature, and pressure. Fluid parameters may include other measurable parameters as well.

In one embodiment, a set of fluid parameters may be associated with fluid entering and/or exiting one or more piping segments of piping system 200. For example, in one embodiment, piping system 200 may include four piping segments, S₁, S₂, S₃, and S₄. S₁ may represent, for example, a straight pipe section having piping parameters PP₁ including length, width (e.g., radius), roughness, external temperature, and external wind velocity. S₂ may represent, for example, a conical segment having piping parameters PP₂ including length, inlet diameter, outlet diameter, roughness, external temperature, and external wind velocity. S₃ may represent, for example, a bent pipe section having piping parameters PP₃ including length, width, roughness, bend angle, bend radius, external temperature, and external wind velocity. S₄ may represent, for example, a muffler having piping parameters PP₄, such as wall thickness, length, external temperature, and external wind velocity.

In one embodiment, fluid parameters FP₁, include parameters associated with the fluid leaving (e.g., output from) fluid generation system 210 and entering (e.g., input to) piping segment S₁ of fluid transfer system 220. In one embodiment, these fluid parameters include fluid pressure, fluid temperature, and fluid flow rate. Because fluid parameters FP₁ represent the initial fluid parameters entering fluid transfer system 220, they may be referred to as initial fluid parameters. In one embodiment, fluid parameters FP₂, FP₃, FP₄, and FP₅ also include fluid pressure, fluid temperature, and fluid flow rate associated with the fluid leaving each associated piping segment and entering the next piping segment. Because fluid parameters FP₅ represent the final fluid parameters exiting fluid transfer system 220, they may be referred to as output fluid parameters. Fluid parameters may also refer to differences between input and output fluid properties (e.g., pressure drop, pressure increase, temperature drop, temperature increase) associated with one or more piping segments.

The disclosed piping system and method may use one or more computer software packages to model and analyze one or more piping systems (e.g., piping system 200 depicted in FIG. 2). In one embodiment, the computer software packages may include computer software for a particular application program. For example, in one embodiment, a computer software package written in Visual Basic™, C++, JavaScript™, etc., may be used with a an application program such as Microsoft Excel™ to implement the systems and methods of the disclosed embodiments. In another embodiment, a computer software package may be written in one or more computer languages (e.g., Java programming language) for use with a Web-based application program (e.g., browser) that can be accessed and used over a network, such as the Internet.

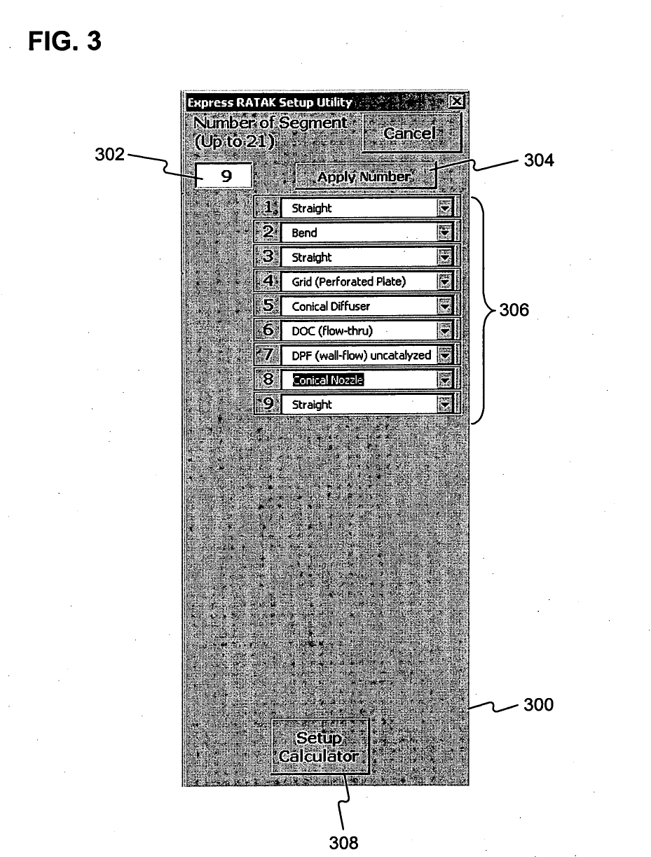

FIG. 3 depicts an exemplary graphical user interface (GUI) 300 consistent with certain disclosed embodiments. GUI 300 and other GUIs described herein may be implemented using any appropriate computer software package and/or application program (e.g., Visual Basic, Microsoft Excel, Java™, etc.). Furthermore, information provided to GUI 300 or other GUIs described herein may be stored in one or more storage devices (e.g., database, application files, computer memory, etc.). In one embodiment, GUI 300 includes drop-down boxes, input boxes, buttons, and/or other known user interface tools that allow a user to select a number of segments to include in a piping system model (e.g., via box 302). In one embodiment, a user may then select “Apply Number” button 304, which results in the display of selectable input boxes 306. Using input boxes 306, the user may then select a desired type of piping segment for each of the segments in the piping system. As shown in FIG. 3, the segment types may include straight segments, bent segments, grid devices, conical diffusers, catalyst (e.g., “DOC”) segments, filter (e.g., “DPF”) segments, conical nozzles, etc. Although only certain types of segments are shown in FIG. 3, additional types of segments may be modeled as well.

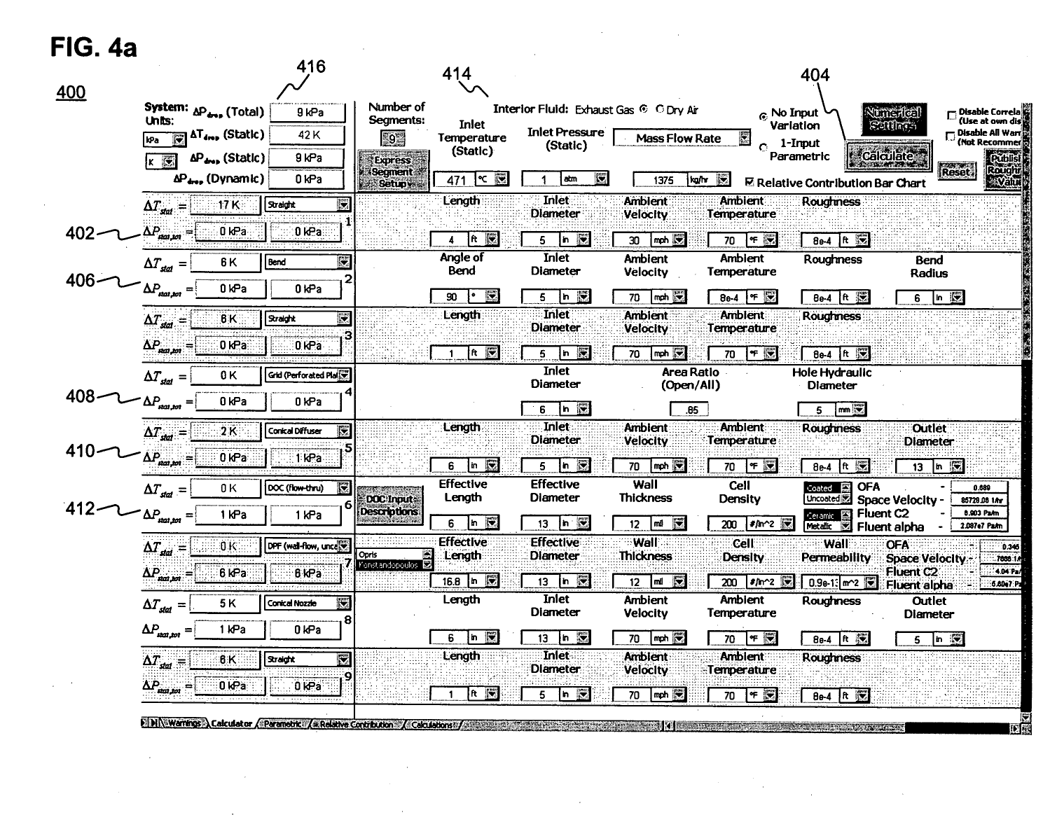

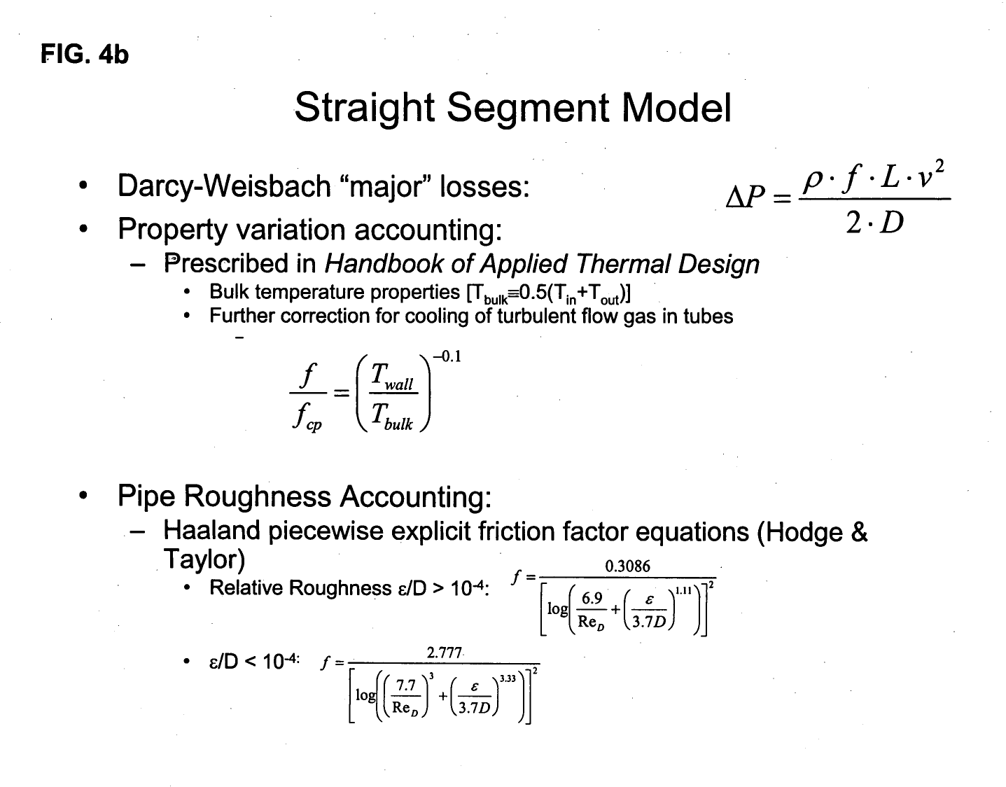

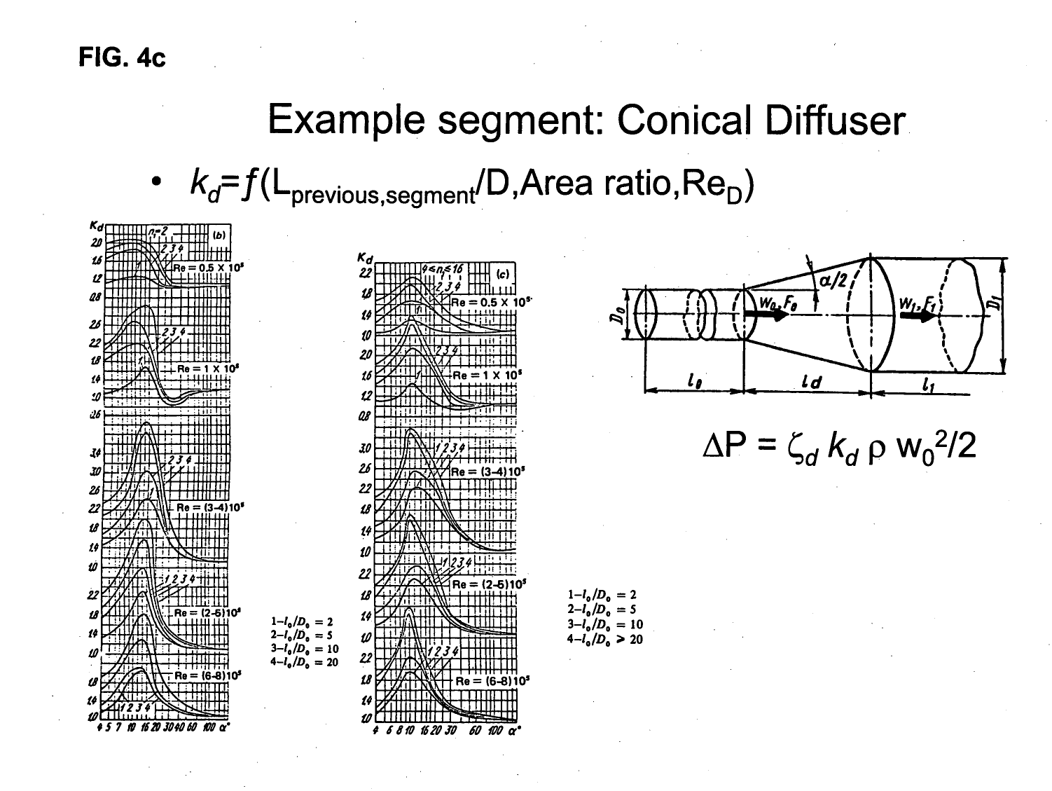

In one embodiment, upon selecting the “Setup Calculator” button 308, a screen such as depicted in FIG. 4a may be displayed. FIG. 4a depicts GUI 400 that may be used to enter information used to determine fluid flow parameter values and changes in fluid flow parameter values for a piping system and for individual segments of the piping system. GUI 400 provides an easy-to-use interface that allows users to input certain piping parameters and automatically calculates fluid parameters based on the input data. Users need not perform or look up any equations or other complicated computations to determine fluid parameters of the segments of the piping system. In one embodiment, the entered information may include piping section type (which in one embodiment is set by default to the type selected via GUI 300), and other information relating to individual piping segments or to the piping system (e.g., piping parameters for each segment).

For example, section 402 of GUI 400 shows an entry area that permits a user to select a piping segment type (e.g., “straight”) and then based on the selection, displays a plurality of entry boxes for entering piping parameter values for the selected piping segment type (e.g., length, inlet diameter, ambient external wind velocity, ambient external temperature, pipe roughness). A user may enter values for each piping parameter. In one embodiment, a warning may be issued if the user enters a value that is outside of a given range of values. This warning may alert the user that, for example, the entered value is too far outside the normal scope of values for that type of piping segment, and may prompt the user to enter a different value. After values have been entered, the user may select a button (e.g., the “Calculate” button 404) that causes one or more fluid parameter values to reflect the entered information. Alternatively, the fluid parameter values may reflect the entered information as soon as data is entered into the piping parameter entry boxes. In one embodiment, as depicted in section 402, a change in temperature, ΔT, and change in pressure, ΔP, of the fluid may be determined based on the entered piping parameters (e.g., ΔT is 17 degrees K, and ΔP is 0 kPa for a straight piping segment having a length of 4 ft., inlet diameter of 5 inches, ambient external wind velocity of 30 mph, ambient external temperature of 70 degrees F., roughness factor of 0.0008 ft., inlet temperature of 471 degrees K, inlet pressure of 1 atm, and inlet flow rate of 1375 kg/hr). The ΔT and ΔP values may reflect static changes (e.g., changes based on a non-moving piping system), dynamic changes (e.g., changes due to movement of the piping system), and/or total changes (e.g., changes based on both static changes and dynamic movement).

In one embodiment, the fluid parameters may be determined based on information stored in connection with the computer software package and application program (hereinafter collectively referred to as the “computer program”). For example, the fluid parameters may be determined based on engineering handbook data or other reference data stored in a database or other storage medium. This reference data will be described further below.

As further depicted in FIG. 4a, GUI 400 may include additional entry areas (e.g., 406, 408, 410, and 412). These entry areas are similar to entry area 402, and permit a user to select a piping segment type and piping parameter values for the selected type. GUI 400 may additionally include initial fluid parameter entry area 414, which in one embodiment, permits a user to enter initial fluid parameter values (e.g., temperature, pressure, fluid flow rate). These initial fluid parameter values may be used to calculate and/or determine fluid parameters for individual segments of the piping system for the piping system as a whole. In one embodiment, GUI 400 includes display area 416, which displays the overall piping system changes in fluid parameters, based in the information provided to entry areas 402, 406, 408, etc. For example, in one embodiment, the overall piping system change in static pressure, ΔP, is 9 kPa, dynamic pressure, ΔP, is 0 kPa, and static temperature, ΔT, is 42 degrees K. Display area 416, as well as the fluid parameter portions of areas 402, 406, 408, 410, and 412 may display individual pressure values and temperature values instead of or in addition to temperature changes and/or pressure changes.

Based on the fluid parameter values determined by the computer program, a user may model and analyze the effects of different factors on the piping system and segments of the piping system. For example, a user may vary certain piping parameter values in GUI 400 and determine how that affects one or more fluid parameters. Based on this determination, the user may suggest that certain piping segments be designed and/or ordered for use in an actual piping system.

As described above, in one embodiment, the fluid parameter values shown in GUI 400 may be determined using engineering handbook data or other reference data stored in a database or other storage medium. As such, rather than calculating fluid parameters based on a complex physics model and/or complex equations derived from the piping parameter values provided to GUI 400, the computer program looks up (e.g., searches for) already stored reference values, equations, and/or graphs that correspond to the provided segment types and/or piping parameters. This process is similar to an engineering handbook lookup, but is done automatically without the need for a user to search handbook or other reference data manually. In one embodiment, reference data may be stored in a database or other storage medium, and may be stored in equation format, table format, graph format or other formats. The data may include known equations specific to certain segment types. In one embodiment, the reference data may be derived from one or more engineering handbooks (e.g., Handbook of Hydraulic Resistance, Idelchik (Koch, 2001)). The reference data may be searched for in a database or other storage medium using any known search technique. By using handbook or other reference look-ups rather than complex physics models, the piping system computer program requires less computational power and is easier to use by an untrained user. Examples of reference information that may be stored in a database or other storage medium are shown in FIGS. 4a and 4b.

FIG. 4b depicts an example of handbook information that may be stored in a database or other storage medium, and used in conjunction with the information provided to GUI 400, for determining a change in fluid pressure as a fluid passes through a straight pipe segment. The handbook information includes a group of equations that collectively, based on an temperature variable, a roughness variable, a length variable, a diameter variable, a fluid density, and a flow velocity, determine a change in pressure in the fluid between the input to the segment and the output from the segment. By storing the equation information in a database or other storage system, the equation information for each type of segment may be easily accessed and used to automatically determine the change in fluid parameter values for that segment. The user need only enter the values for certain variables (e.g., inlet temperature, length, inlet diameter, ambient temperature, ambient wind velocity, roughness, etc.) and the computer program determines the output fluid parameter based on the entered information.

Additional reference information may be stored for any type of segment. For example, FIG. 4c shows handbook information related to a conical diffuser, that may be used to determine a change in fluid pressure through the diffuser. Equations, as well as tables and graphs, for determining output fluid parameters (e.g., temperature, pressure, change in temperature, and change in pressure, etc.) based on input variables (e.g., length, diameter, roughness, etc.), for various types of piping segments are generally known in the art. The system of the disclosed embodiments stores reference equations, tables, and charts, and accesses them via a computer program to quickly determine the output fluid parameters for each segment based on provided piping parameters. The computer program then treats the output fluid parameter values from a previous piping segment as the input fluid parameter values to the next piping segment. Accordingly, the computer program can determine modular fluid parameter values for each piping segment and can use those values to determine fluid parameter values for subsequent segments, and for the piping system as a whole.

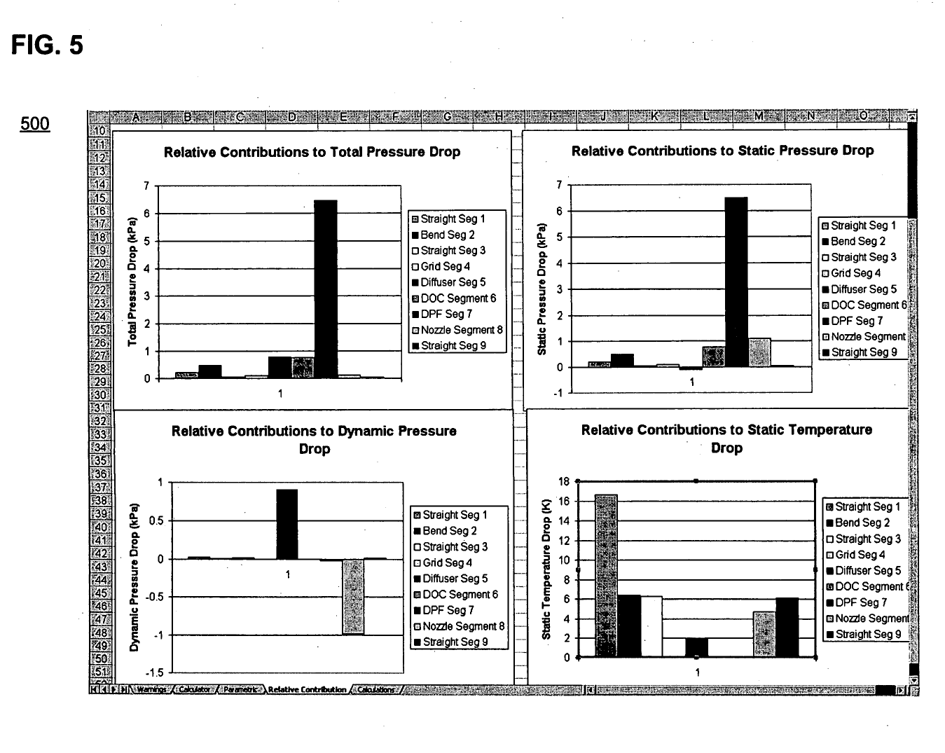

In one embodiment, the computer program may include an additional GUI 500, shown in FIG. 5, that displays one or more charts comparing relative contributions in parameter value changes of each segment of the piping system to the overall parameter value changes of the entire piping system. For example, in one embodiment, based on the ΔP and ΔT values determined and displayed in GUI 400, GUI 500 may display a bar chart or other type of visual aid that compares the contribution of each piping segment to the overall piping system for each of total pressure drop, static pressure drop, dynamic pressure drop, and static temperature drop. By displaying the contributions visually, a user may easily view which piping segments have the greatest or least effect on different fluid parameters. The user may then alter the piping system design, if desired.

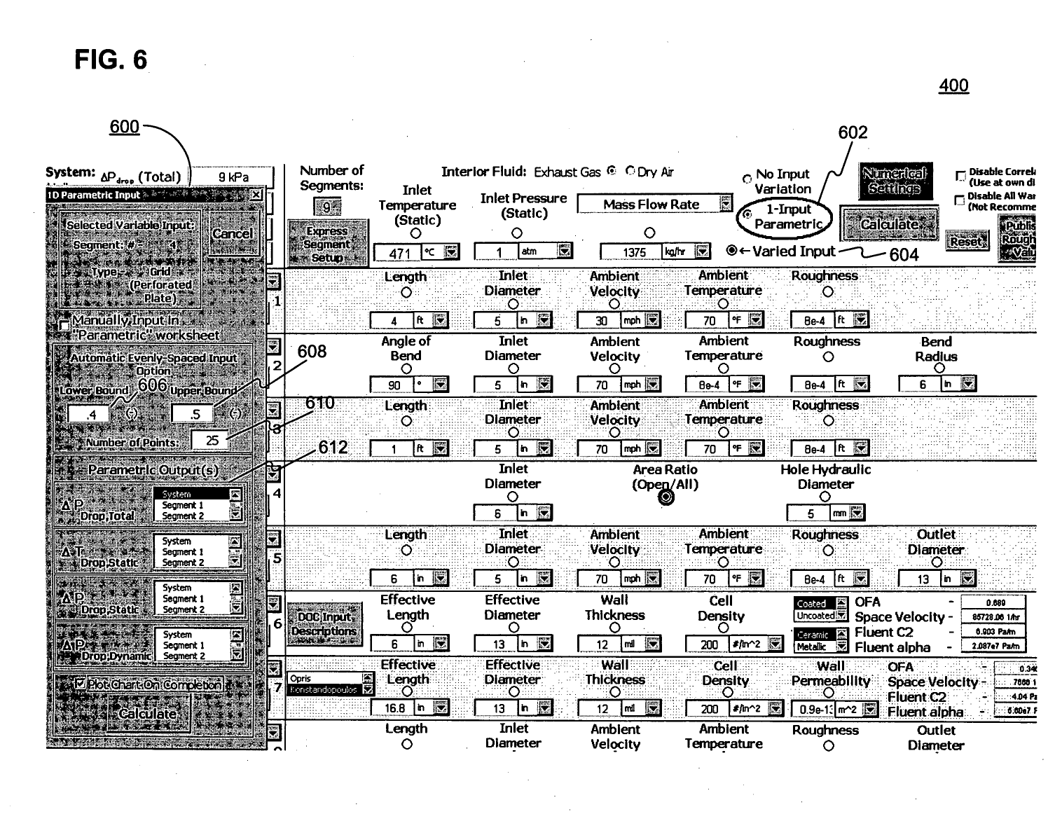

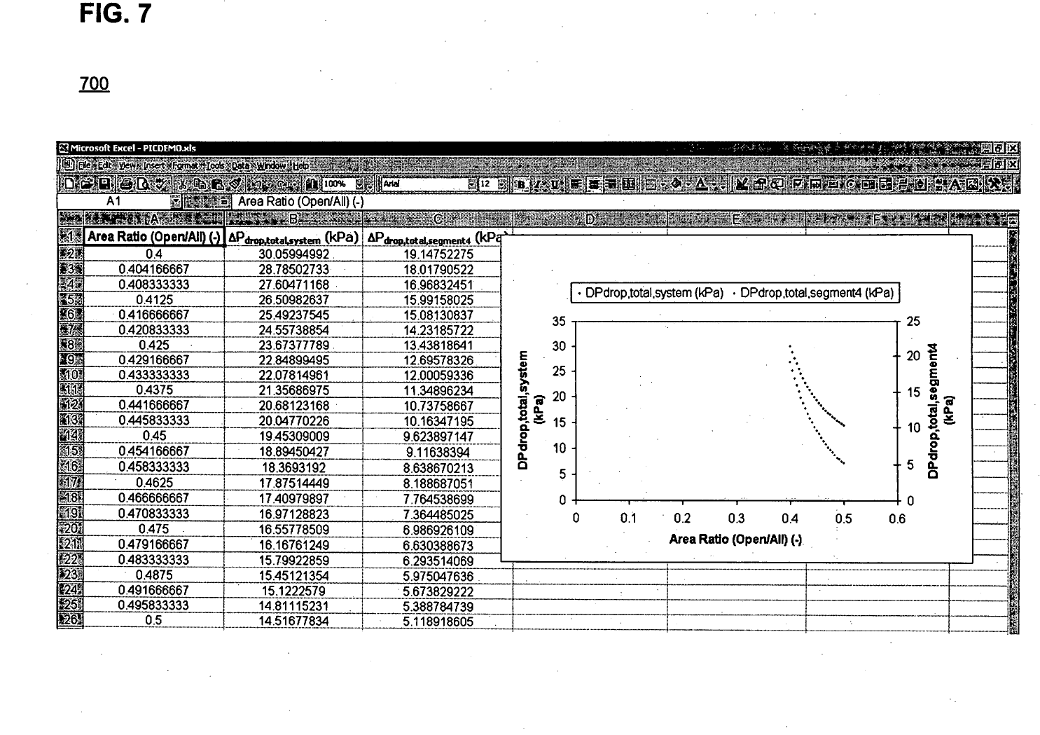

In another embodiment, the computer program may include additional GUIs 600 and 700, shown in FIGS. 6 and 7 respectively. In one embodiment, GUI 600 may be used when a user selects the “1-Input Parametric” option 602 and “Varied Input” option 604 in GUI 400. The “1-Input Parametric” option 602 and “Varied Input” option 604 permit a user to vary a single piping parameter for a single piping segment (e.g., Area Ratio for segment 4, as depicted in FIG. 6). In one embodiment, all other piping parameters for all other segments remain constant. By varying the one piping parameter for a single piping segment, the user may determine a range of fluid output parameter values for a range of the varied piping parameter values. In one embodiment, the fluid output parameter values may then be graphed against the piping parameter values, as depicted in FIG. 7. The graph may be used by a user to analyze the piping parameter, segment, and/or system, and to determine which piping parameter value for the varied piping parameter is optimal for the piping system. As a result of the analysis, the user may design or order piping segments having the optimal piping parameter value for an actual piping system.

In one embodiment, GUI 600 additionally includes entry areas 606, 608, 610, and 612. Entry areas 606 and 608 permit a user to enter a lower bound value (e.g., 0.4) and upper bound value (e.g., 0.5) for the piping parameter to be varied. Entry area 610 permits a user to enter the number of points to plot (e.g., 25). Alternatively, the user may manually enter the points to plot. Entry area 612 permits the user to select a fluid parameter to plot. For example, the user may select any single fluid parameter for any single piping segment or for the piping system as a whole to plot against the points determined from entry areas 606, 608, and 610. For example, in the exemplary embodiment depicted in FIGS. 6 and 7, the computer program determines a system ΔP total drop that corresponds to each of 25 Area Ratio inputs between 0.4 and 0.5. The values are then shown in FIG. 7, both in a table format and a graphical format. The values and selections depicted in FIGS. 6 and 7 are exemplary only. In other embodiments, any piping parameter for any piping segment may be analyzed against any output fluid parameter for any piping segment or for the piping system as a whole.

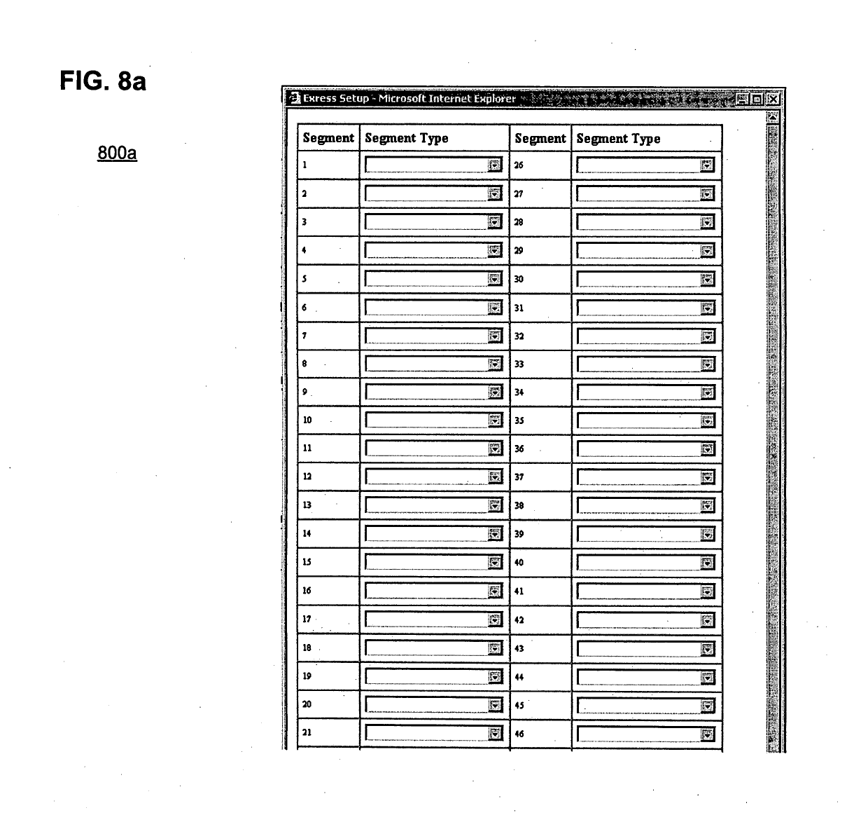

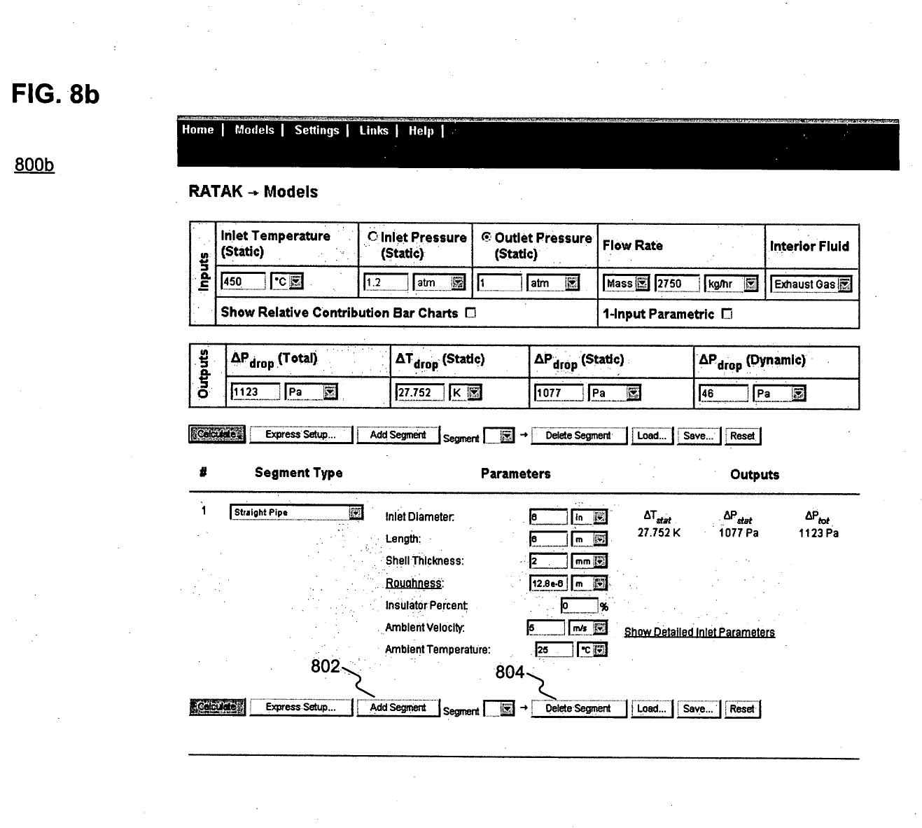

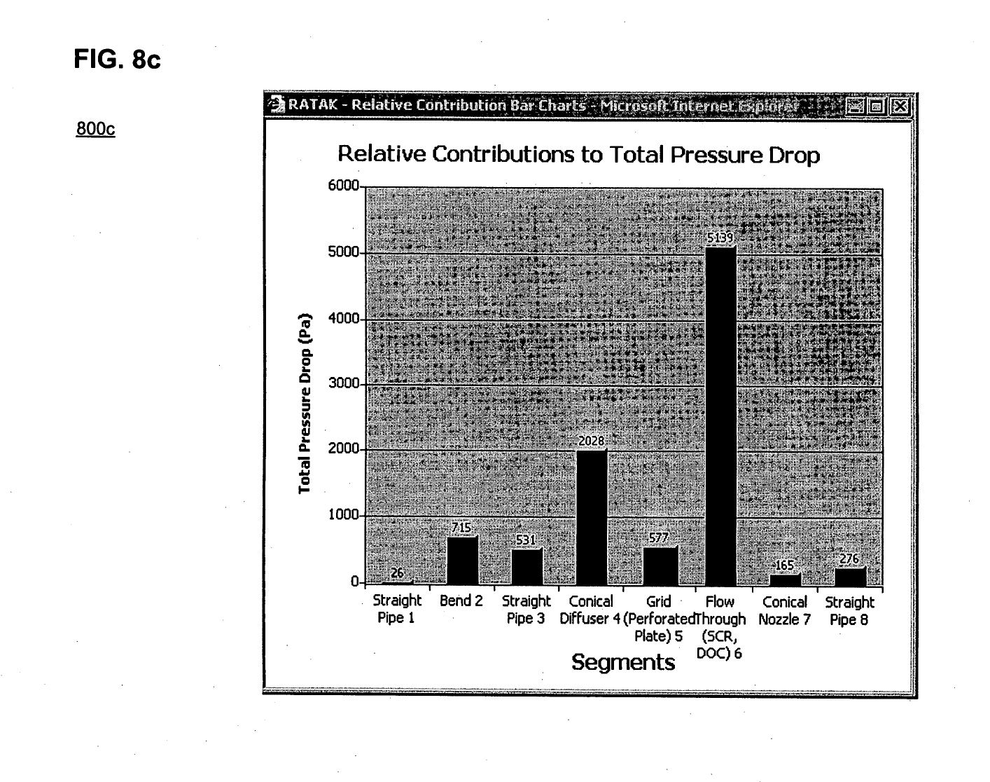

As described above, the disclosed GUIs may be designed using any suitable programming language and/or application program. In one embodiment, the GUIs comprise web-based GUIs which may be accessed over a network, such as the Internet, or via a stand-alone computer system. For example, FIGS. 8a, 8b, and 8c illustrate exemplary web-based GUIs consistent with certain disclosed embodiments. FIGS. 8a and 8b depict GUIs 800a and 800b, which may be used to perform the same types of functions discussed previously in connection with GUI 300 and GUI 400. For example, GUI 800a may be used in the same manner as GUI 300, permitting a user to enter segment types for each segment to be included in the piping system model. In addition, GUI 800b may be used in the same manner as GUI 400. For example, GUI 800b may permit a user to provide initial fluid parameter values for the piping system and piping parameters for each segment of the piping system, and may also permit a user to view resulting fluid parameter values for each of one or more segments and/or for the piping system as a whole. GUI 800b may additionally include “add segment” button 802 and “delete segment” button 804, which allow a user to quickly add and delete segments to the piping system being modeled without the need to access a separate segment setup window. FIG. 8c depicts GUI 800c, which may be used to display the same type of data discussed previously in connection with FIG. 5.

Web based GUIs such as shown in FIGS. 8a, 8b, and 8c may be implemented using any programming language (e.g., HTML, Java, XML, etc.) suitable for use with a Web browser (e.g. Microsoft Explorer browser, Netscape browser, etc.) or other application program. Furthermore, Web based GUIs may be implemented on any suitable computer system, such as a PC, PDA, cell phone, or other device capable of accessing the Internet.

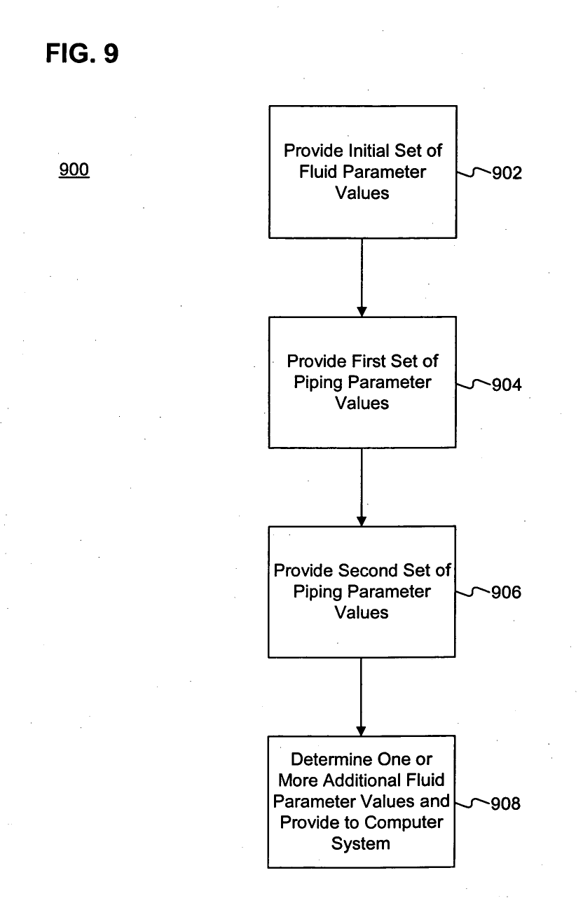

FIG. 9 is a block diagram of an exemplary method 900 consistent with certain disclosed embodiments. The method may be implemented using a system such as described in connection with FIG. 1 and/or one or more GUIs such as described in connection with FIGS. 3-7. Although method 900 is depicted as including a number of steps, the steps need not be performed in the order described below.

In step 902, an initial set of fluid parameter values is provided. In one embodiment, the values may be provided via a GUI, such as depicted in FIG. 4a. The values may reflect fluid parameter values output from a fluid generation system, such as an engine, water supply system, or other system. In one embodiment, the fluid parameters include an initial fluid temperature, an initial fluid pressure, and an initial fluid flow rate.

In step 904, a first set of piping parameter values is provided. In one embodiment, the values may be provided via a GUI, such as depicted in FIG. 4a. The values may reflect a piping segment type, as well as piping parameters associated with the piping segment type. For example, in one embodiment, the piping segment type may be a straight piping segment and the associated parameters may include segment length, segment diameter, segment roughness, external temperature, and external wind velocity. In step 906, a second set of piping parameter values is provided. The second set also includes a piping segment type and one or more associated piping parameters. Additional sets of piping parameter values for additional piping segments may be provided as well.

In step 908, one or more additional fluid parameter values are determined based at least on the initial set of fluid parameter values, the first set of piping parameter values, and the second set of piping parameter values. The one or more additional fluid parameter values are then provided to a computer system. For example, the additional fluid parameter values may be provided to an application program, such as Microsoft Excel, or a similar Web-based program. In one embodiment, the additional fluid parameters may include one or more of a fluid temperature, fluid pressure, total, static, or dynamic change in fluid temperature, and total, static, or dynamic change in fluid pressure. The additional fluid parameter values may reflect fluid parameters in single segment of the piping system or fluid parameters associated with the piping system as a whole. In one embodiment, the additional fluid parameter values are displayed in a GUI (e.g., GUI 400). In another embodiment, based on an analysis of the additional fluid parameters, a designer of the piping system may design and/or build an actual piping system using the provided piping segments and parameters.

### INDUSTRIAL APPLICABILITY

The disclosed embodiments may be used for any piping system that uses piping segments to transfer fluid. Examples of piping systems include exhaust systems (e.g., for vehicles and other engine systems), water transfer systems, steam piping systems, etc. Furthermore, the disclosed embodiments may be used in any user environment. For example, in one embodiment, the disclosed systems and methods may be used by designers as an easy way to estimate certain design parameters of piping segments. In another embodiment, the disclosed systems and methods may be used by in an educational environment to teach students how different parameters affect pipe flows. In another embodiment, manufacturers may use the disclosed systems and methods to determine which types of piping segments to manufacture.

Although certain GUIs are described herein, the systems and methods of the disclosed embodiments are not limited to the format and/or software programs depicted in the drawings. For example, different input boxes, chart types, and visual displays may be used. Information may be input into one or more GUIs using any known input device (e.g., mouse, touch pad, voice activated software, etc.). Further, any application program capable of performing the disclosed embodiments may be used. By including an easy to use GUI coupled with a handbook lookup feature, the disclosed embodiments permit both skilled and non-skilled users to design and evaluate model piping segments and systems.

It will be apparent to those skilled in the art that various modifications and variations can be made to the system and method for determining pipe flow parameters. Other embodiments will be apparent to those skilled in the art from consideration of the specification and practice of the disclosed embodiments. It is intended that the specification and examples be considered as exemplary only, with a true scope being indicated by the following claims and their equivalents.

What is claimed is:

1. A method for providing one or more fluid parameter values of a piping system, the method comprising:
providing one or more initial fluid parameter values as an initial set of fluid parameter values;
providing one or more piping parameter values for a first segment of the piping system as a first set of piping parameter values;
providing one or more piping parameter values for a second segment of the piping system as a second set of piping parameter values;
automatically determining one or more additional fluid parameter values of the piping system, based at least on the initial set of fluid parameter values, the first set of piping parameter values, and the second set of piping parameter values; and
providing the one or more additional fluid parameter values to a computer system.

2. The method of claim 1, wherein automatically determining the one or more additional fluid parameter values includes searching stored reference data.

3. The method of claim 2, wherein the stored reference data includes handbook data including at least one of a stored numerical value, a stored equation, and a stored graph.

4. The method of claim 1, wherein providing the one or more piping parameter values for the first segment and the second segment includes inputting the one or more piping parameter values for the first segment and the second segment via a graphical user interface.

5. The method of claim 4, wherein the graphical user interface is a Web based interface.

6. The method of claim 1, wherein automatically determining the one or more additional fluid parameter values of the piping system further includes:
determining one or more fluid parameter values for at least one of the first and second segments;
determining one or more fluid parameter values for the overall piping system; and
providing the determined fluid parameter values to a computer system.

7. The method of claim 1, wherein the one or more additional fluid parameters include one or more of an atmospheric pressure, a temperature, a change in atmospheric pressure, and a change in temperature.

8. The method of claim 1, further including:
determining a difference between a provided initial fluid parameter value for the piping system and a determined fluid output parameter value of the piping system, thereby establishing a first delta value;
determining a difference between a fluid parameter value associated with fluid input into a segment of the piping system and a fluid parameter value associated with fluid output from the segment, thereby establishing a second delta value;
determining a percentage that the segment contributes to the overall piping system change in the fluid parameter value by dividing the second delta value by the first delta value; and
displaying an indication of the percentage in a display.

9. The method of claim 1, further including:
determining a plurality of fluid parameter values for a particular fluid parameter of a particular portion of the piping system as a function of a respective plurality of piping parameter values for a particular piping parameter of the first segment of the piping system; and
graphing the plurality of fluid parameter values against the plurality of piping parameter values.

10. A computer program product comprising a computer readable medium with computer program instructions stored thereon, the computer program instructions causing a computer system to perform the steps of:
storing one or more initial fluid parameter values as an initial set of fluid parameter values;
storing one or more piping parameter values for a first segment of the piping system as a first set of piping parameters value;
storing one or more piping parameter values for a second segment of the piping system as a second set of piping parameter values;
automatically determining the one or more additional fluid parameter values of the piping system, based at least on the initial set of fluid parameter values, the first set of piping parameter values, and the second set of piping parameter values; and
storing the one or more additional fluid parameter values.

11. The computer program product of claim 10, wherein the computer program instructions further cause the computer system to automatically determine the one or more additional fluid parameter values of the piping system by searching stored reference data.

12. The computer program product of claim 11, wherein the stored reference data includes handbook data including at least one of a numerical value, an equation, and a graph.

13. The computer program product of claim 10, wherein the computer program instructions further cause the computer system to store the one or more piping parameter values for the first segment and the second segment via a graphical user interface.

14. The computer program product of claim 13, wherein the graphical user interface is a Web based interface.

15. The computer program product of claim 10, wherein the computer program instructions further cause the computer system to:
determine one or more fluid parameter values for at least one of the first and second segments;
determine one or more fluid parameter values for the overall piping system; and
store the determined fluid parameter values.

16. The computer program product of claim 10, wherein the one or more additional fluid parameters include one or more of an atmospheric pressure, a temperature, a change in atmospheric pressure, and a change in temperature.

17. The computer program product of claim 10, wherein the computer program instructions further cause the computers system to:
determine a difference between a provided initial fluid parameter value for the piping system and a determined fluid output parameter value of the piping system, thereby establishing a first delta value;
determine a difference between a fluid parameter value associated with fluid input into a segment of the piping system and a fluid parameter value associated with fluid output from the segment, thereby establishing a second delta value;
determine a percentage that the segment contributes to the overall piping system change in the fluid parameter value by dividing the second delta value by the first delta value; and
display an indication of the percentage.

18. The method of claim 10, wherein the computer program instructions further cause the computer system to:
determine a plurality of fluid parameter values for a particular fluid parameter of a particular portion of the piping system as a function of a respective plurality of piping parameter values for a particular piping parameter of the first segment of the piping system; and
graph the plurality of fluid parameter values against the plurality of piping parameter values.

19. A method of simultaneously displaying one or more fluid parameter values for a segment of a piping system and one or more fluid parameter values for the overall piping system, comprising:
receiving one or more initial fluid parameter values as an initial set of fluid parameter values;
receiving one or more piping parameter values for a first piping segment of the piping system as a first set of piping parameter values via a graphical user interface;
receiving one or more piping parameter values for a second piping segment of the piping system as a second set of piping parameter values via a graphical user interface;
based at least on the initial set of fluid parameter values, the first set of piping parameter values, and the second set of piping parameter values, automatically determining the one or more fluid parameter values for the overall piping system;
automatically determining the one or more fluid parameter values for the first segment of the piping system, based at least on the initial set of fluid parameter values and the first set of piping parameter values; and
simultaneously displaying the one or more fluid parameter values for the overall piping system and the one or more fluid parameter values for the first segment of the piping system.

20. The method of claim 19, wherein the determined one or more fluid parameters for the overall piping system are one or more of a change in temperature and a change in pressure, and the determined one or more fluid parameters for the first segment of the piping system are one or more of a change in temperature and a change in pressure.
